(19) United States
(12) Patent Application Publication
(10) Pub. No.: US 2006/0165173 A1
(43) Pub. Date: Jul. 27, 2006

(54) Method of managing MPEG-4 object information in MPEG-2 transport stream

(75) Inventors: Sang-Ho Kim, Hwaseong-si (KR); Jun-Ho Koh, Suwon-si (KR); Jong-Kwon Kim, Gunpo-si (KR); Sang-Mo Hong, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/337,326

(22) Filed: Jan. 23, 2006

(30) Foreign Application Priority Data
Jan. 27, 2005 (KR) 7598/2005

(51) Int. Cl. H04N 7/12; H04N 11/04; H04B 1/66; H04N 11/02

(52) U.S. Cl. 375/240.12

(57) ABSTRACT

Disclosed is a method of managing a Motion Picture Expert Group-2 Transport Stream (MPEG-2 TS) in an object unit of an MPEG-4 by efficiently matching the MPEG-4 with the MPEG-2 TS, in order to broadcast an internet protocol (IP). The method manages MPEG-4 object information in an MPEG-2 TS status, by adding the object information to a program map table (PMT) in the course of converting an MPEG-4 data into an MPEG-2 TS. The method includes the steps of: a) receiving an MPEG-4 SL (Sync Layer) to be transmitted as an MPEG-2 TS; b) acquiring an object information from the MPEG-4 SL; c) aligning the acquired object information corresponding to a program map table (PMT) of the MPEG-2 TS; and d) creating an MPEG-2 TS which has the PMT corresponding to the object information.

### CLAIM OF PRIORITY

This application claims the benefit of an earlier filed application entitled “METHOD OF MANAGING MPEG-4 OBJECT INFORMATION IN MPEG-2 TRANSPORT STREAM,” filed in the Korean Intellectual Property Office on Jan. 27, 2005 and assigned Serial No. 2005-7598, the entire contents of which are incorporated herein by reference.

### BACKGROUND OF THE INVENTION

1. Field of the Invention

The present invention relates to a method of managing a Motion Picture Expert Group-2 Transport Stream (MPEG-2 TS) in an object unit of an MPEG-4 by efficiently matching the MPEG-4 with the MPEG-2 TS, in order to broadcast an internet protocol (IP).

2. Description of the Related Art

The MPEG represents an organization for promoting the standardization of compressing and decompressing schemes for motion pictures and its related audio signals, and works under the name of “Working Group 11 (WG 11)” under SC 29 (Sub-Committee 29), which establishes an international standard of a multimedia-related coding scheme. The SC 29 is a sub-organization of JTCI (Joint Technical Committee for International Standardization Associated with Information Processing) administered by both ISO (International Organization for Standardization) and IEC (International Electrotechnical Commission).

The MPEG has proposed MPEG-1and MPEG-2 as standards, and the adoption of MPEG-4 is now being considered.

The MPEG-1 refers to a technique for storing 300 full-color images per second at a resolution of “320×480”, which is employed for a video compact disc (CD) or the like. The MPEG-2 refers to a technique for supporting a resolution of “708×480”, which is employed for a digital video disc (DVD) or the like. According to the MPEG-1 and MPEG-2, when a bit stream, which has been generated by compressing moving picture and voice information input at a predetermined size based on a predetermined data processing amount, is transmitted, a receiving terminal decodes the bit stream and reproduces the moving picture and voice through a display and a speaker.

Unlike the MPEG-1 and MPEG-2 which transmit images in a unit of frame, according to the MPEG-4, an image is transmitted with objects and background thereof being divided, and a receiving terminal combines the objects and background to form a single image. The MPEG-4 enables about 130 hours of moving pictures to be stored in a single CD. As such, the MPEG-4 plays a important role in a conversation function required in a mobile terminal, a video conference, etc.

The difference between the MPEG-4 and the prior standards (i.e. MPEG-1 and MPEG-2) lays in their sources. According to the MPEG-4, a screen including audio and visual data can be constructed as a set of objects of specific parts. In other words, one screen can be configured as a set of various visual objects, such as a person, a vehicle, a tree, a sky, a bird, a cloud, etc. As described above, since the MPEG-4 separates and compresses each object from an image, the MPEG-4 enables moving picture contents to be stored in a higher compression rate than the MPEG-2 under the condition of the same screen quality.

FIG. 1 illustrates a process of converting an MPEG-4 into an MPEG-2 TS.

An access unit (AU) 11, which is moving picture data, is divided into two parts 13-1 and 13-2, and SL headers 12-1 and 12-2 for an MPEG-4 packet are attached to the divided parts 13-1 and 13-2, thereby creating SL packets. Then, packetized ES (PES) headers 14-1 and 14-2 are added to the SL packets 15-1 and 15-2, respectively, thereby forming PES packets. Next, each PES packet is converted into a TS packet, thereby forming an MPEG-2 TS.

Herein, each TS packet is set with 188 bytes, in which a TS header 16-1, 16-2, or 16-3 is included. In addition, each TS packet includes PES packet data 17-1, 17-2, or 17-3, which has been obtained by dividing the PES packet to be suitable for the 188 bytes.

When an MPEG-4 packet has been converted into an MPEG-2 TS packet as described above, it is not possible to obtain information for each object from the MPEG-4 packet, and further it is not possible to edit each object. In other words, in order to check information about each object from the MPEG-2 TS, it is necessary to convert the MPEG-2 TS into the SL packet including the SL headers 12-1 and 12-2.

That is, when an MPEG-4 is transmitted using an MPEG-2 TS according to the prior art, in order to confirm the status of each object, it is necessary to check a descriptor in an MPEG-4 SL (Sync Layer) or MPEG-4 ES after converting the MPEG-2 TS into the MPEG-4 SL or MPEG-4 ES via a PES packet.

### SUMMARY OF THE INVENTION

Accordingly, the present invention has been made to solve the above-mentioned problems occurring in the prior art and provides additional advantages, by providing a method of managing MPEG-4 object information in an MPEG-2 TS status, by adding the object information to a program map table (PMT) in the course of converting an MPEG-4 data into an MPEG-2 TS.

One aspect of the present invention is to provide a method of enabling the user to filter each object from an MPEG-2 TS based on the object information.

In one embodiment, there is provided a method of managing motion picture expert group-4 (MPEG-4) object information in an MPEG-2 transport stream (TS). The method includes the steps of: a) receiving an MPEG-4 SL (Sync Layer) to be transmitted as an MPEG-2 TS; b) acquiring object information from the MPEG-4 SL; c) aligning the acquired object information corresponding to a program map table (PMT) of the MPEG-2 TS; and d) creating an MPEG-2 TS which has the PMT corresponding to the object information.

In another embodiment, there is provided a method of managing motion picture expert group-4 (MPEG-4) object information in an MPEG-2 transport stream (TS). The method includes the steps of: a) receiving the MPEG-2 TS; b) detecting a program access table (PAT) and a program map table (PMT) from the received MPEG-2 TS; c) obtaining an object information included in the PMT according to a user request; and d) performing an operation according to the user request based on the obtained object information.

### BRIEF DESCRIPTION OF THE DRAWINGS

The above features and advantages of the present invention will be more apparent from the following detailed description taken in conjunction with the accompanying drawings, in which:

FIG. 1 illustrates a process of converting an MPEG-4 into an MPEG-2 TS;

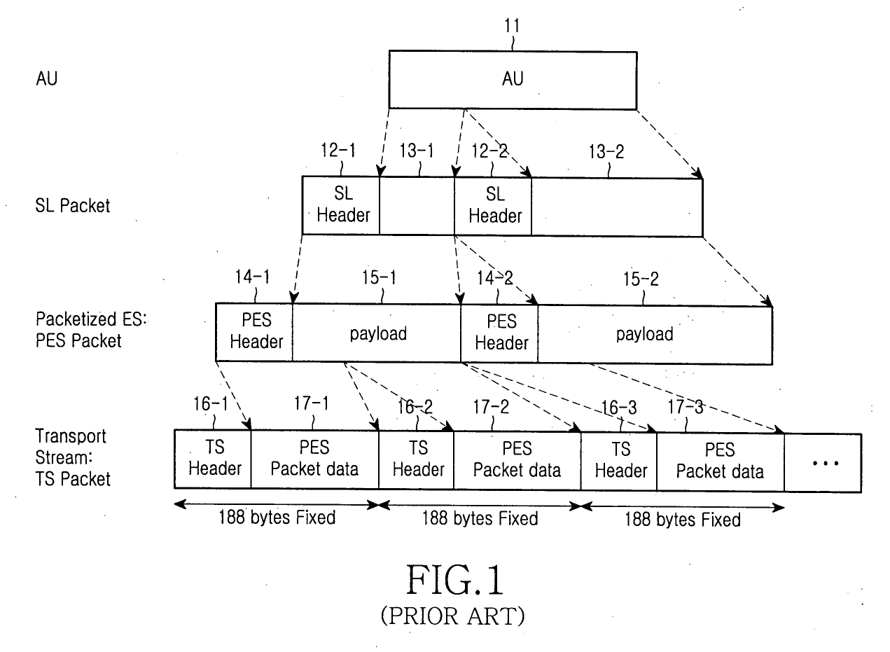

FIG. 2 is a flowchart illustrating a method of adding an MPEG-4 object information to an MPEG-2 TS according to an embodiment of the present invention; and

FIG. 3 is a flowchart illustrating a method of filtering data of an MPEG-4 object information according to a user's request after an MPEG-2 TS has been received according to an embodiment of the present invention.

### DETAILED DESCRIPTION

Hereinafter, an embodiment according to the present invention will be described with reference to the accompanying drawings. For the purposes of clarity and simplicity, a detailed description of known functions and configurations incorporated herein will be omitted as it may obscure the subject matter of the present invention.

According to an embodiment of the present invention, an object information of an MPEG-4 data is added to a program map table (PMT) of an MPEG-2 TS.

Table 1 shows an example of a PMT of an MPEG-2 TS, to which the present invention is applied.

TABLE 1

| Syntax | No. of bits | Mnemonic |
|---|---|---|
| TS_program_map_section( ) { | | |
| table_id | 8 | uimsbf |
| section_syntax_indicator | 1 | bslbf |
| ‘0’ | 1 | bslbf |
| reserved | 2 | bslbf |
| section_length | 12 | uimsbf |
| program_number | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| reserved | 3 | bslbf |
| PCR_PID | 13 | uimsbf |
| reserved | 4 | bslbf |
| program_info_length | 12 | uimsbf |
| for (i=0; i<N; i++) { | | |
| descriptor( ) | | |
| } | | |
| for (i=0; i<N1; i++) { | | |
| stream_type | 8 | uimsbf |
| reserved | 3 | bslbf |
| elementary_PID | 13 | uimsbf |
| reserved | 4 | bslbf |
| ES_info_length | 12 | uimsbf |
| for (i=0; i<N2; i++) { | | |
| descriptor( ) | | |
| } | | |
| } | | |
| CRC_32 | 32 | rpchof |
| } | | |

Table 2 shows an example of information about the stream type of a PMT of an MPEG-2 TS, to which the present invention is applied. According to an embodiment of the present invention, MPEG-4 object information is expressed in the user private regions of “0×80” to “0×FF”.

That is, since MPEG-4 information is expressed in the PMT of an MPEG-2 TS, it is possible to reduce processing steps of extracting an object desired by the user.

TABLE 2

| Value | Descriptor |
|---|---|
| 0x00 | ITU-T\|ISO/IEC reserved |
| 0x01 | ISO/IEC 11172 Video |
| 0x02 | ITU-T Rec. H.262\|ISO/IEC |
| | 13818-2 Video or ISO/IEC |
| | 11172-2 constrained parameter |
| | video stream |
| 0x03 | ISO/IEC 11172 Audio |
| 0x04 | ISO/IEC 13818-3 Audio |
| 0x05 | ITU-T Rec. H.222.0\|ISO/IEC |
| | 13818-1 private_section |
| 0x06 | ITU-T Rec. H.222.0\|ISO/IEC |
| | 13818-1 PES packet |
| | containing private data |
| 0x07 | ISO/IEC 13522 MHEG |
| 0x08 | ITU-T Rec. H.222.0\|ISO/IEC |
| | 13818-1 Annex A DSMCC |
| 0x09 | ITU-T Rec. H.222.1 |
| 0x0A | ISO/IEC 13818-6 type A |
| 0x0B | ISO/IEC 13818-6 type B |
| 0x0C | ISO/IEC 13818-6 type C |
| 0x0D | ISO/IEC 13818-6 type D |
| 0x0E | ITU-T Rec. H.222.0\|ISO/IEC |
| | 13818-1 auxiliary |
| 0x0F | ISO/IEC 13818-7 Audio with |
| | ADTS transport syntax |
| 0x10 | ISO/IEC 14496-2 Visual |
| 0x11 | ISO/IEC 14496-3 Audio with the |
| | LATM transport syntax as |
| | defined in ISO/IEC 14496-3/ |
| | AMD 1 |
| 0x12 | ISO/IEC 14496-1 SL-packetized |
| | stream or FlexMux stream |
| | carried in PES packets |
| 0x13 | ISO/IEC 14496-1 SL-packetized |
| | stream or FlexMux stream |
| | carried in ISO/IEC 14496- |
| | sections |
| 0x14 | ISO/IEC 13818-6 Synchronized |
| | Download Protocol |
| 0x15-0x7F | ITU-T Rec. H.222.0\|ISO/IEC |
| | 13818-1 reserved |
| 0x80-0xFF | User private |

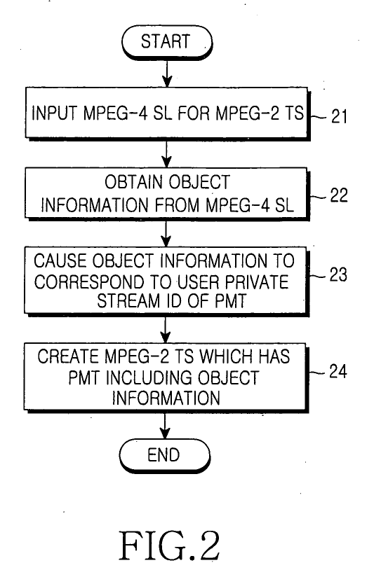

Table 3 shows an example of a table in which MPEG-4 object information is expressed in the user private regions having stream IDs of “0×80” to “0×FF”, in the information about the stream type of a PMT of an MPEG-2 TS shown in FIG. 2.

TABLE 3

| Stream ID | MPEG-4 Object |
|---|---|
| 0x80 | Video Object 1 |
| 0x81 | Video Object 2 |
| . . . | . . . |
| 0xa0 | Audio Object 1 |
| 0xa1 | Audio Object 2 |
| . . . | . . . |
| 0xc0 | Text Object 0 |
| | Text Object 1 |
| . . . | . . . |
| 0xe0 | etc Object 0 |
| . . . | . . . |

Referring to Table 3, video objects are expressed in the user private regions of “0×80” to “0×9F”, audio objects are expressed in the user private regions of “0×0” to “0×bF”, text objects are expressed in the user private regions of “0×c0” to “0×dF”, and remaining objects are expressed in the user private regions of “0×e0” to “0×FF”. When object IDs are allocated to video, audio, text, etc. in Table 1, a mapping loop using stream ID (stream types) and ES PIDs is repeated as shown in Table 1.

The expression of object information as shown in Table 3 is realized through a mapping by an FPGA or processor.

FIG. 2 is a flowchart illustrating a method for adding MPEG-4 object information to an MPEG-2 TS according to an embodiment of the present invention.

According to the method of adding MPEG-4 object information to an MPEG-2 TS, first, an MPEG-4 SL (Sync Layer) for an MPEG-2 TS is input in step 21.

In step 22, object information is acquired from the input MPEG-4 SL.

In step 23, the acquired object information are aligned corresponding to user private stream IDs in a PMT of the MPEG-2 TS. Herein, as an example, the user private stream IDs in the PMT of the MPEG-2 TS have the values of “0×80” to “0×FF”.

In step 24, an MPEG-2 TS having the PMT, in which object information corresponds to user private stream IDs, is created.

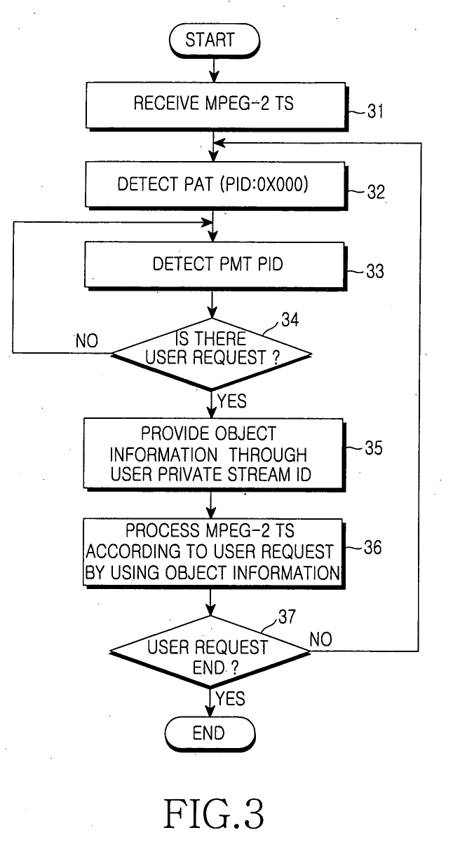

FIG. 3 is a flowchart illustrating a method of filtering data of MPEG-4 object information according to a user's request after an MPEG-2 TS has been received according to an embodiment of the present invention.

According to the data filtering method based on the MPEG-4 object information, first, an MPEG-2 TS is received in step 31. Herein, the MPEG-2 TS is a transport stream, in which MPEG-4 object information is aligned corresponding to user private stream IDs through a procedure as described with reference to FIG. 2.

In step 32, a PAT is detected from the received MPEG-2 TS. Herein, it is assumed that the PAT has the PID value of “0×00”.

In step 33, the PMT PID is detected using the detected PAT. The present invention has a special characteristic in that an object information acquired from an MPEG-4 SL is aligned corresponding to user private stream IDs in a PMT of an MPEG-2 TS. Herein, it is assumed that user private stream IDs in a PMT of an MPEG-2 TS have values of “0×80” to “0×FF” shown in Table 1.

In step 34, it is determined whether the user requests a filtering operation with respect to a specific object information. Herein, the filtering request of the user may be a request for removing the data corresponding to the specific object information, or may be a request for selecting the data corresponding to the specific object information.

When it is determined that there is no filtering request in step 34, the procedure returns to step 33. If it is determined that there is a filtering request in step 34, a relevant object information is obtained by means of a user private stream ID included in the PMT in step 35, and then a filtering operation of the MPEG-2 TS is performed, according to the user request, using the obtained object information in step 36. These steps are repeated until no more user requests exist (step 37).

According to the present invention as described above, when an MPEG-2 TS over MPEG-4, which is used in DVB-H and DMB (Digital Multimedia Broadcasting), is transmitted, it is possible to check the status of each object of MPEG-4 in the MPEG-2 TS, so that transmission data can be easily modified according to the user's request.

In the prior art, an MPEG-2 TS must be converted into an MPEG-4 in order to manage each object of the MPEG-4. However, according to the present invention, it is possible to enable the management for each object of an MPEG-4 even in an MPEG-2 TS status, so that the operation steps of a relevant process are reduced. Further, it should be noted that the method according to the present invention can be realized by a program and can be stored in a recording medium (such as a CD ROM, a RAM, a floppy disk, a hard disk, a magneto-optical disk, etc.) in a format that can be read by a computer.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for managing a motion picture expert group-4 (MPEG-4) object information in an MPEG-2 transport stream (TS), the method comprising the steps of:
a) receiving an MPEG-4 SL (Sync Layer) to be transmitted as an MPEG-2 TS;
b) acquiring an object information from the MPEG-4 SL;
c) aligning the acquired object information corresponding to a program map table (PMT) of the MPEG-2 TS; and
d) creating an MPEG-2 TS which has the PMT corresponding to the object information.

2. The method as claimed in claim 1, wherein, in step c), the acquired object information is aligned corresponding to a user private stream ID in the PMT of the MPEG-2 TS.

3. The method as claimed in claim 2, wherein the user private stream ID in the PMT of the MPEG-2 TS is included in user private regions of “0×80” to “0×FF”.

4. A method for managing a motion picture expert group-4 (MPEG-4) object information in an MPEG-2 transport stream (TS), the method comprising the steps of:
a) receiving the MPEG-2 TS;
b) detecting a program access table (PAT) and a program map table (PMT) from the received MPEG-2 TS;
c) obtaining object information included in the PMT according to a user's request; and
d) performing an operation according to the user's request based on the obtained object information.

5. The method as claimed in claim 4, wherein the MPEG-2 TS is a transport stream in which object information acquired from an MPEG-4 SL (Sync Layer) is aligned corresponding to a user private stream ID in the PMT of the MPEG-2 TS.

6. The method as claimed in claim 4, further comprising step e) of repeating steps b) to d) until no more user's requests exist.

7. The method as claimed in claim 6, wherein the operation according to the user request is an operation for selecting an MPEG-2 TS including the object information.

8. The method as claimed in claim 6, wherein the operation according to the user request is an operation for removing an MPEG-2 TS including the object information.
